(19) United States
(12) Patent Application Publication
(10) Pub. No.: US 2005/0252920 A1
(43) Pub. Date: Nov. 17, 2005

(54) Paint roller tray

(75) Inventors: Alisdair Cumming, Kingstone (GB); Stephen Rowlay, Sheffield (GB); Eric Ranieri, West Hartford, CT (US)

Correspondence Address: PILLSBURY WINTHROP SHAW PITTMAN, LLP, P.O. BOX 10500, MCLEAN, VA, 22102, US

(73) Assignee: THE STANLEY WORKS, New Britain, CT (US)

(21) Appl. No.: 10/844,571

(22) Filed: May 13, 2004

(51) Int. Cl. B05C 17/00; B05C 21/00

(52) U.S. Cl. 220/570; 15/257.05; 118/258; 206/229; 220/495.02

(57) ABSTRACT

A paint roller tray is provided with a removable cover. The paint roller tray includes a paint brush support formed in a front side of the tray, front and back paint roller support notches, a pour spout, a hanging fixture, and support legs. The cover includes paint roller and paint brush accommodating bulges that allow the cover to be mounted to the tray while a paint roller and a paint brush are disposed wholly or partially between the tray and cover.

### BACKGROUND OF THE INVENTION

1. Field of the Invention

This invention relates to paint roller trays with covers, and specifically relates to paint roller trays that are adapted to support paint rollers and paint brushes.

2. Description of Related Art

Various conventional paint roller trays include covers that are designed to prevent paint therein from quickly drying. U.S. Pat. No. 5,645,164 discloses one such covered paint roller tray. As shown in FIG. 3 thereof, a paint roller and a paint brush may be supported on the paint roller tray. Unfortunately, as would be appreciated by one of ordinary skill in the art, resting the paint brush on the paint roller tray frequently interferes with the use of the paint roller tray by the paint roller because the paint brush disadvantageously occupies the roll-out platform used by the paint roller.

U.S. Pat. No. 6,622,884 discloses a conventional paint roller tray that includes a pour spout to aid in pouring paint out of the paint roller tray.

There is a need for a paint tray that accommodates both a roller and a brush. There is also a need for a paint tray that adapts to a variety of uses, including painting, pouring, and storage.

### SUMMARY OF THE INVENTION

As aspect of one or more embodiments of this invention relates to providing a paint tray that accommodates a brush and a roller in a shared container.

Another aspect of one or more embodiments of this invention relates to a paint tray that is configured to assist in the pouring of paint.

Another aspect of one or more embodiments of this invention relates to a paint tray that is configured to permit the tray to be hung for storage.

Another aspect of one or more embodiments of this invention relates to a paint tray that is configured to be stacked with a plurality of identical paint trays.

Another aspect of one or more embodiments of this invention provides a paint roller tray that includes a paint brush support that does not interfere with a paint roller's use of the paint roller tray and roll-out platform.

Another aspect of one or more embodiments of the present invention provides a paint roller tray that includes a useful combination of one or more of the following features: a cover, a hanging fixture for hanging the tray when not in use, front and rear support notches for a paint roller, a paint brush support notch that does not interfere with use of the tray by a paint roller, a bulge in the cover that is shaped so that a paint brush and a paint roller may be entirely enclosed within the tray between the cover and a tray body, a pour spout that facilitates the easy pouring of paint out of the tray, and slip-resisting surface features disposed on an underside of the tray.

Another aspect of one or more embodiments of the present invention provides a paint roller tray that includes a tray body having opposing spaced front and back walls, opposing spaced side walls joining the front and back walls, and a bottom that joins to lower portions of the walls. The bottom defines a sloped rollout platform and a paint well. The sloped rollout platform slopes downwardly toward the paint well. The tray also includes a cover removably mounted to the tray body. The cover has a front, a back, and two side portions that engage a top edge of the tray body. The cover and tray body are shaped to completely enclose a paint roller therebetween.

According to a further aspect of one or more of these embodiments, the cover has a forward portion toward the front of the cover with an upwardly extending paint roller handle bulge therein. The paint roller handle bulge is shaped to complement a handle of a paint roller.

According to a further aspect of one or more of these embodiments, the tray is combined with a paint roller that is completely enclosed between the cover and the tray body. The paint roller has a handle that is at least partially disposed in the paint roller handle bulge of the cover. The tray may also be combined with a paint brush.

According to a further aspect of one or more of these embodiments, a paint brush support is disposed in the tray body. The paint brush support is shaped to support a paint brush.

The paint brush support may have a paint brush support wall that extends upwardly from the bottom of the tray body, wherein a space for a paint brush is defined between the paint brush support wall and one of the side walls. A paint brush may be supported in the paint brush support. The paint brush support may be disposed at a front side corner of the tray body. The paint brush support defines a trough that is shaped to accommodate a paint brush. The paint brush support has a bottom surface that slopes downwardly toward the paint well to drain excess paint from a paint brush into the paint well. The paint brush support may include a paint brush notch formed in a top edge of the front wall, the notch being shaped to support a handle of a paint brush that extends forwardly over the top of the front wall.

According to a further aspect of one or more of these embodiments, the cover has an upwardly extending paint brush bulge formed therein. The paint brush bulge is positioned to complement the paint brush notch. The paint brush bulge and notch are adapted to surround a paint brush handle such that the cover may be mounted to the tray body when a paint brush is disposed in the paint brush support.

According to a further aspect of one or more of these embodiments, a space for a paint brush is defined between the paint brush support wall and one of the side walls. The space for a paint brush has a height and a width. The height is greater than the width. The paint brush notch is deeper than it is wide.

According to a further aspect of one or more of these embodiments, the paint brush support comprises a rearward wall that is shaped to stop a paint brush from sliding rearwardly toward the paint well.

According to a further aspect of one or more of these embodiments, the tray includes a pour spout formed at an intersection between one of the side walls and the back wall. The pour spout is shaped to pour paint from the paint roller tray. Each corner between adjacent ones of the side, front, and back walls has a radius. A radius of the pour spout is larger than a radius of at least one of the other three corners.

According to a further aspect of one or more of these embodiments, the tray also includes a rear paint roller support notch formed in a top edge of the back wall. The rear paint roller support notch is shaped to complement a frame of a paint roller.

According to a further aspect of one or more of these embodiments, a paint roller accommodating notch is formed in a bottom rearward portion of the cover. The rear paint roller support notch and paint roller accommodating notch define a hole that is shaped to accommodate a paint roller frame extending therethrough. The roller body of a paint roller may be disposed between the cover and the tray body such that the frame of the paint roller extends through the hole. A front paint roller support notch may be formed in a top edge of the front wall. The front paint roller support notch is shaped to support a frame of a paint roller.

According to a further aspect of one or more of these embodiments, the tray includes a hanging fixture extending forwardly from a front end of the tray body. The hanging fixture is shaped to engage a hook such that the paint roller tray can hang on the hook.

According to a further aspect of one or more of these embodiments, the cover is transparent. The tray body and cover may each be formed from molded plastic.

According to a further aspect of one or more of these embodiments, the tray includes at least one leg extending downwardly from the bottom of the tray body. The paint roller tray is stackable with other identical paint roller trays.

According to a further aspect of one or more of these embodiments, the cover has an upwardly extending paint brush accommodating notch formed therein. The paint brush accommodating notch is positioned to complement the paint brush notch. The paint brush accommodating notch and the paint brush notch are shaped to surround a paint brush handle such that the cover may be mounted to the tray body when a paint brush is disposed in the paint brush support.

According to a further aspect of one or more of these embodiments, a back paint roller support notch is formed in the top edge of the back wall. The back paint roller support notch is shaped to complement a paint roller frame.

According to a further aspect of one or more of these embodiments, at least one slip-resisting surface feature is disposed on a lower surface of the bottom wall.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which from a part of this original disclosure:

FIG. 1 is a left side perspective view of a paint roller tray with a cover according to one embodiment of the present invention;

FIG. 2 is a left side perspective view of three stacked paint roller trays with and without covers according to the embodiment illustrated in FIG. 1;

FIG. 3 is a rear perspective view of the paint roller trays illustrated in FIG. 2, with a paint brush and paint roller; and

FIG. 4 is a bottom perspective view of the paint roller tray in FIG. 1.

### DETAILED DESCRIPTION OF PREFERRED EMBODIMENTS OF THE INVENTION

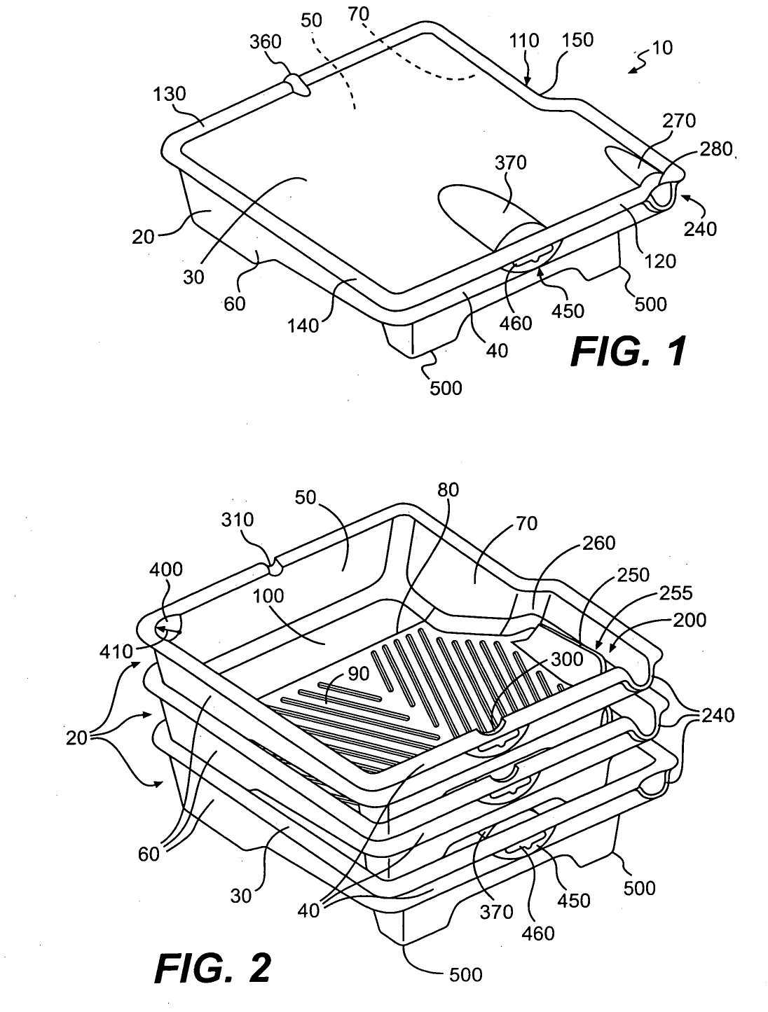

FIG. 1 illustrates a paint roller tray 10 according to an embodiment of the present invention. The paint roller tray 10 includes a tray body 20 and a selectively removable cover 30. The tray body 20 and cover 30 are preferably each formed of molded plastic, but may alternatively comprise any other suitable material such as stamped metal, cast metal, etc. The cover 30 preferably comprises a clear plastic so that any paint, brushes, or other objects in the tray 10 can be seen through the cover 30.

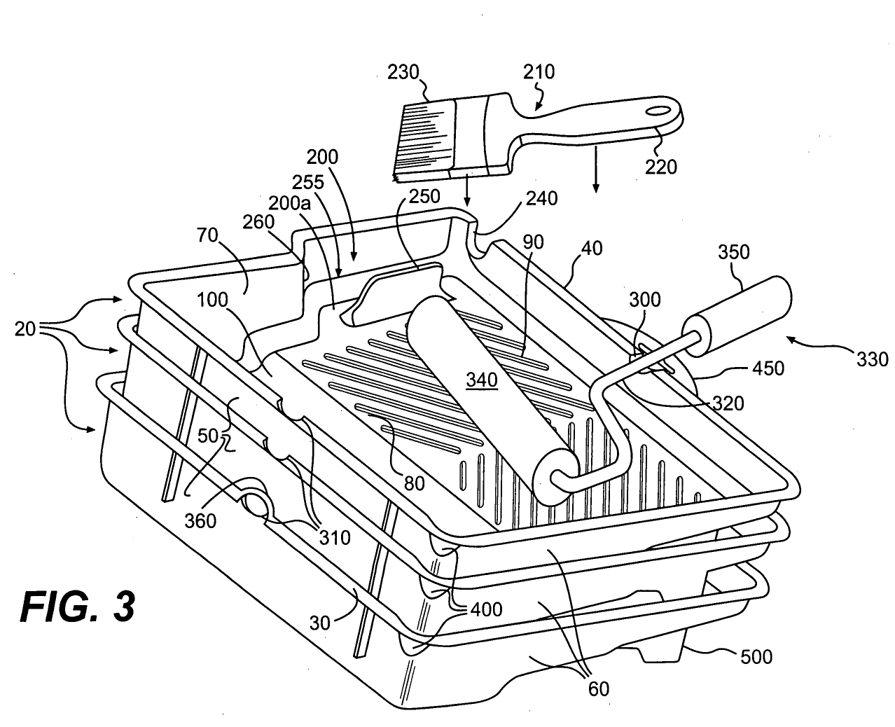

As shown in FIGS. 2 and 3, the tray body 20 has opposing front and back walls 40, 50, and opposing left and right side walls 60, 70 that join with the front and back walls 40, 50 to form an open topped space, which generally forms a rectangular shape. The tray body 20 also includes a bottom 80 that joins to lower portions of the walls 40, 50, 60, 70. The bottom 80 defines a sloped rollout platform 90. The bottom 80, back wall 50, and side walls 60, 70 define a paint well 100. The sloped rollout platform 90 slopes downwardly from the front wall 40 and steps down to the paint well 100 so that paint on the sloped rollout platform 90 flows toward and into the paint well 100.

As shown in FIG. 1, the cover 30 has front, back, and side portions 120, 130, 140, 150 that define a lip 110 that engages top edges of the front, back, and side walls 40, 50, 60, 70, respectively, so that the cover 30 is removably mounted to the tray body 20. The lip 110 may securely snap onto the tray body 20 or loosely fit onto the tray body 20. The cover 30 and tray body 20 do not create an air-tight seal, as discussed below, but generally protect any paint in the paint well 100 from outside debris and discourage the paint from rapidly drying.

As described below, the following features are incorporated into the paint roller tray 10: a paint brush support 200, front and back paint roller support notches 300, 310, a pour spout 400, a hanging fixture 460, and support legs 500.

As shown in FIGS. 2 and 3, a paint brush support 200 is disposed in a front corner of the tray body 20 between the side wall 70 and the front wall 40. As shown in FIG. 3, the paint brush support 200 is shaped to compliment a paint brush 210 that includes a handle 220 and a paint-applying end 230. The paint brush support 200 includes a bottom surface 200a that slopes downwardly toward the paint well 100 to drain excess paint from the paint-applying end 230 of the paint brush 210 into the paint well 100. The paint brush support 200 includes a paint brush notch 240 that is formed in the top edge of the front wall 40. As shown in FIGS. 2 and 3, the notch 240 is preferably deeper than it is wide. The notch 240 is shaped to support the handle 220 of the paint brush 220 in an upright position such that the handle 220 can extend forwardly from the tray body 20 over the top of the front wall 40, while the paint-applying end 230 of the brush remains in the paint brush support 200.

The paint brush support 200 also includes a paint brush support wall 250 that extends upwardly from the bottom 80 of the tray body 20 between the bottom surface 200a and the rollout platform 90. The paint brush support wall 250 is generally parallel to an adjacent portion of the side wall 70 such that a separation between the side wall 70 and the paint brush support wall 250 defines a width of the paint brush support 200. The paint brush support wall 25, side wall 70, and bottom surface 200a combine to define a U-shaped trough 255 in which the paint brush 210 lays. The paint brush support 200 includes a rearward wall (or other projection) 260 that stops the paint brush 210 from sliding rearwardly toward or into the paint well 100. In the illustrated embodiment, the rearward wall 260 is defined by the side wall 70 of the tray body 20, but may alternatively comprise a distinct wall like the paint brush support wall 250.

The paint brush support 200 has a height that is defined as the higher of (a) the side wall 70 in the area of the paint brush support 200, or (b) the height of the paint brush support wall 250. The height of the paint brush support 200 is greater than its width. The paint brush support 200 is shaped to support the paint brush 210 in an upright position wherein the handle 220 extends in a generally front-back direction of the tray body and the flat part of the paint-applying end 230 of the brush 210 extends generally vertically. The narrow width of the notch 240 abuts opposing flat sides of the handle 220 to help keep the paint brush 210 in this upright position. This upright positioning facilitates the draining of paint from the brush 210 into the paint well 100.

While the illustrated paint brush support 200 is shaped to support the paint brush 210 in an upright position, the paint brush support may alternatively be shaped to support the paint brush in a flat position. In such an embodiment, the paint brush support would be wider than it is high.

As shown in FIG. 1, the cover 30 has an upwardly extending bulge 270 and notch 280 that are positioned to compliment the paint brush support 200 and notch 240, respectively. The bulge 270 and notch 280 are shaped to surround and cover any portion of the paint brush 210 that extends upwardly above the paint brush support 200 when the brush is disposed in the paint brush support 200. The bulge 270 and notch 280 therefore allow the cover 30 to mount to the tray body 20 even when the paint brush 210 is disposed in the paint brush support 200. Alternatively, if the paint brush support 200 and notch 240 are sufficiently deep that they extend higher than the paint brush 210, the bulge 270 and notch 280 in the cover 30 may be omitted. The paint brush 210 may also be stored in the paint well 100 completely between the tray body 20 and cover 30 when the tray 10 is not being used.

As shown in FIGS. 2 and 3, front and rear paint roller support notches 300, 310 are formed in the top edges of the front and rear walls 40, 50. As shown in FIG. 3, the notches 300, 310 are each shaped to compliment a wire frame 320 of a paint roller 330. The notches 300, 310 preferably have an arcuate shape that closely resembles a cross-sectional shape of the wire frame 320. The complementary shapes of the frame 320 and notches 300, 310 frictionally contact each other to help prevent the wire frame 320 from sliding relative to the notches 300, 310 in a forward and rearward direction of the tray 10. The paint roller 330 has a body 340 rotationally mounted to the frame 320 and a handle 350 mounted to an opposite end of the frame 320, as is known.

As shown in FIGS. 1 and 3, the cover 30 includes a paint roller accommodating notch 360 that extends upwardly into the back portion 130 of the cover 30. As shown in FIG. 3, the notch 360 is positioned to complement and abut the notch 310 in the tray body 20 to define a hole that is shaped to accommodate the paint roller frame 320 extending therethrough. The cover 30 may therefore be mounted to the tray body 20 while the paint roller frame 320 is supported by the support notch 310 such that the handle 350 is disposed rearwardly of the tray 10 and the roller body 340 is disposed between the cover 30 and the tray body 20. When the roller 330 is supported by the notch 310, the roller body 340 is preferably disposed on the rollout platform 90 forward of paint that is disposed in the paint well 100, or the roller body 340 may alternatively be stored in the paint well 100, if desired.

As shown in FIG. 1, the cover 30 includes a paint roller handle bulge 370 that extends upwardly into a forward middle portion of the cover 30 and the front portion 120 thereof. The bulge 370 is shaped to complement the handle 350 of the paint roller 330 (see FIG. 3) such that the tray body 20 and cover 30 can completely enclose the paint roller 330 therebetween when the tray 10 is not being used. When the paint roller 330 is completely enclosed within the tray 10, the roller body 340 is disposed in the paint well 100.

The paint roller 330 and one or more brushes 210 may be packaged with the tray body 20 and mounted cover 30 for sale. The brush(es) 210 may be disposed in the paint well 100 and/or in the paint brush support 200. The roller 330 may be disposed completely inside the tray 10 with the handle 350 being positioned in the bulge 370. Alternatively, the roller 330 may be packaged in the notch 310 so that the handle is disposed outside of the tray 10.

As shown in FIG. 2, the tray 10 includes a pour spout 400 that is formed in the tray body 20 at an intersection between the side wall 60 and the rear wall 50. The pour spout 400 is shaped to facilitate the pouring of paint from the paint well 100. Each corner between adjacent ones of the side, front, and back walls 40, 50, 60, 70 has an inner radius. A radius 410 of the pour spout 400 is larger than a radius of at least one of the other three corners to facilitate pouring. A pour spout may additionally and/or alternatively be formed at the intersection between the side wall 70 and the rear wall 50.

As shown in FIGS. 1 and 2, the tray 10 includes a hanging fixture 450, which protrudes forwardly from the front wall 40 of the tray body 20. The hanging fixture 450 includes a hole 460 or other notch, slot, etc. that is shaped to engage a hook such that the paint roller tray may be hung on the hook when not in use.

As shown in FIGS. 1-3, support legs 500 extend downwardly from the rollout platform 90. The support legs preferably extend downwardly far enough that their lower edges are level with a bottom of the paint well 100. The support legs 500 and the bottom of the paint well 100 together keep the tray 10 upright and stable and provide a slope to the rollout platform 90. As shown in FIGS. 2 and 3, the tray body 20 is shaped such that when the covers 30 are removed, plural tray bodies 20 are tightly stackable (see the top two tray bodies 20 in FIGS. 2 and 3). Similarly, when the covers 30 are mounted onto the tray bodies 20, plural trays 10 are stackable in a more spread apart manner (see the lower two trays 10 in FIGS. 2 and 3).

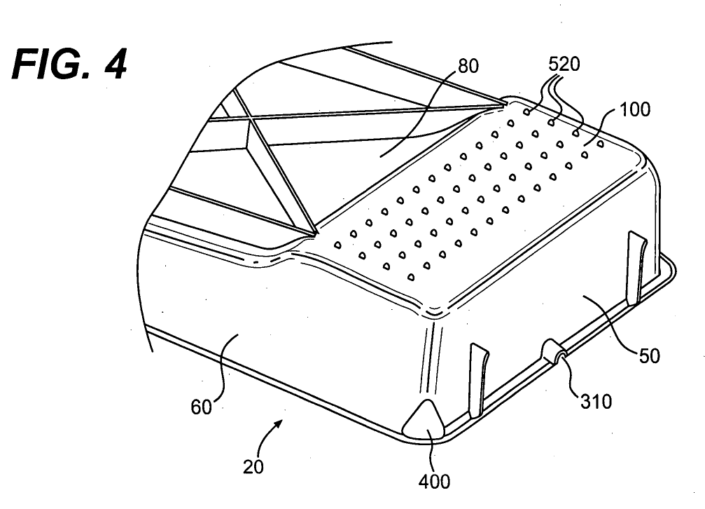

As shown in FIG. 4, a lower surface of the bottom 80 of the tray body 20 includes surface features 520 in the vicinity of the paint well 100. The surface features 520 discourage the tray body 20 from slipping when placed on a work surface. The illustrated surface features 520 comprise raised dots or protrusions that form a stippled surface. However, any other surface feature that increases the tray's resistance to slipping could alternatively and/or additionally be used without deviating from the scope of the present invention. Alternative surface features include raised or dimpled shapes, protrusions, extrusions, or lines, a rubberized surface, etc.

While the illustrated tray 10 includes a paint brush support 200, front and back paint roller support notches 300, 310, a pour spout 400, a hanging fixture 460, support legs 500, and slip-resisting surface features 520, a paint roller tray according to the present invention could alternatively include any combination of one or more of these features. The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

1. A paint roller tray comprising:
a tray body having opposing spaced front and back walls, opposing spaced side walls joining the front and back walls, and a bottom that joins to lower portions of the walls, the bottom defining a sloped rollout platform and a paint well, the sloped rollout platform sloping downwardly toward the paint well; and
a cover removably mounted to the tray body, the cover having a front, a back, and two side portions that engage a top edge of the tray body,
wherein the cover and tray body are shaped to completely enclose a paint roller therebetween.

2. The paint roller tray of claim 1, wherein the cover has a forward portion toward the front of the cover with an upwardly extending paint roller handle bulge therein, and wherein the paint roller handle bulge is shaped to complement a handle of a paint roller.

3. The paint roller tray of claim 2, in combination with a paint roller that is completely enclosed between the cover and the tray body, the paint roller having a handle that is at least partially disposed in the paint roller handle bulge of the cover.

4. The paint roller tray of claim 1, further comprising a paint brush support disposed in the tray body, the paint brush support being shaped to support a paint brush.

5. The paint roller tray of claim 4, wherein the paint brush support comprises a paint brush support wall that extends upwardly from the bottom of the tray body, wherein a space for a paint brush is defined between the paint brush support wall and one of the side walls.

6. The paint roller tray of claim 4, in combination with a paint brush supported in the paint brush support.

7. The paint roller tray of claim 6, in combination with a paint roller that is completely enclosed between the cover and the tray body.

8. The paint roller tray of claim 4, wherein the paint brush support is disposed at a front side corner of the tray body.

9. The paint roller tray of claim 4, wherein the paint brush support has a trough shaped to accommodate a paint brush.

10. The paint roller tray of claim 4, wherein the paint brush support has a bottom surface that slopes downwardly toward the paint well to drain excess paint from a paint brush into the paint well.

11. The paint roller tray of claim 10, wherein the paint brush support comprises a paint brush notch formed in a top edge of the front wall, the notch being shaped to support a handle of a paint brush that extends forwardly over the top of the front wall.

12. The paint roller tray of claim 11, wherein the cover has an upwardly extending paint brush bulge formed therein, wherein the paint brush bulge is positioned to complement the paint brush notch, wherein the paint brush bulge and notch are adapted to surround a paint brush handle such that the cover may be mounted to the tray body when a paint brush is disposed in the paint brush support.

13. The paint roller tray of claim 11, wherein the paint brush support comprises a paint brush support wall that extends upwardly from the bottom of the tray body, wherein a space for a paint brush is defined between the paint brush support wall and one of the side walls.

14. The paint roller tray of claim 13, wherein the space for a paint brush has a height and a width, wherein the height is greater than the width.

15. The paint roller tray of claim 11, wherein the paint brush notch is deeper than it is wide.

16. The paint roller tray of claim 10, wherein the paint brush support comprises a rearward wall that is shaped to stop a paint brush from sliding rearwardly toward the paint well.

17. The paint roller tray of claim 1, further comprising a pour spout formed at an intersection between one of the side walls and the back wall, the pour spout being shaped to pour paint from the paint roller tray.

18. The paint roller tray of claim 17, wherein each corner between adjacent ones of the side, front, and back walls has a radius, and wherein a radius of the pour spout is larger than a radius of at least one of the other three corners.

19. The paint roller tray of claim 1, further comprising a rear paint roller support notch formed in a top edge of the back wall, the rear paint roller support notch being shaped to complement a frame of a paint roller.

20. The paint roller tray of claim 19, wherein a paint roller accommodating notch is formed in a bottom rearward portion of the cover, and wherein the rear paint roller support notch and paint roller accommodating notch define a hole that is shaped to accommodate a paint roller frame extending therethrough.

21. The paint roller tray of claim 20, in combination with a paint roller having a roller body and a frame, wherein the roller body is disposed between the cover and the tray body and the frame extends through the hole.

22. The paint roller tray of claim 19, further comprising a front paint roller support notch formed in a top edge of the front wall, the front paint roller support notch being shaped to support a frame of a paint roller.

23. The paint roller tray of claim 1, further comprising a hanging fixture extending forwardly from a front end of the tray body, the hanging fixture being shaped to engage a hook such that the paint roller tray can hang on the hook.

24. The paint roller tray of claim 1, wherein the cover is transparent.

25. The paint roller tray of claim 1, further comprising at least one leg extending downwardly from the bottom of the tray body, wherein the paint roller tray is stackable with other identical paint roller trays.

26. The paint roller tray of claim 1, wherein the tray body and the cover each comprise molded plastic.

27. The paint roller tray of claim 1, further comprising at least one slip-resisting surface feature disposed on a lower surface of the bottom.

28. A paint roller tray comprising:
a tray body having opposing spaced front and back walls, opposing spaced side walls joining the front and back walls, and a bottom that joins to lower portions of the walls, the bottom defining a sloped rollout platform and a paint well, the sloped rollout platform sloping downwardly toward the paint well;
a cover removably mounted to the tray body, the cover having a front, a back, and two side portions that engage a top edge of the tray body; and
a paint brush support disposed in a front side corner of the tray body, the paint brush support being shaped to support a paint brush, the paint brush support comprising
a paint brush support wall that extends upwardly from the bottom of the tray body, and
a trough defined between the paint brush support wall and one of the side walls, the trough being shaped to accommodate a paint brush.

29. The paint roller tray of claim 28, wherein the paint brush support comprises a rearward wall that stops a paint brush from sliding rearwardly toward the paint well.

30. The paint roller tray of claim 28, in combination with a paint brush supported in the paint brush support.

31. The paint roller tray of claim 30, in combination with a paint roller that is completely enclosed between the cover and the tray body.

32. The paint roller tray of claim 28, wherein the paint brush support has a bottom surface that defines a bottom surface of the trough, and wherein the trough slopes downwardly toward the paint well to drain excess paint from a paint brush into the paint well.

33. The paint roller tray of claim 32, wherein the paint brush support comprises a paint brush notch formed in a top edge of the front wall, the notch being shaped to support a handle of a paint brush that extends forwardly over the top of the front wall.

34. The paint roller tray of claim 33, wherein the cover has an upwardly extending paint brush accommodating notch formed therein, wherein the paint brush accommodating notch is positioned to complement the paint brush notch, wherein the paint brush accommodating notch and the paint brush notch are shaped to surround a paint brush handle such that the cover may be mounted to the tray body when a paint brush is disposed in the paint brush support.

35. The paint roller tray of claim 33, wherein the space for a paint brush has a height and a width, wherein the height is greater than the width.

36. A paint roller tray comprising:
a front wall having a top edge, a front paint roller support notch being formed in the top edge of the front wall, the front paint roller support notch being shaped to complement a paint roller frame;
a back wall having a top edge, a back paint roller support notch being formed in the top edge of the back wall, the back paint roller support notch being shaped to complement a paint roller frame;
opposing spaced side walls joining the front and back walls; and
a bottom wall that joins to lower portions of the front, back, and side walls, the bottom wall defining a sloped rollout platform and a paint well, the sloped rollout platform sloping downwardly toward the paint well.

37. The paint roller tray of claim 36, in combination with a cover removably mounted to the paint roller tray, the cover having a front, a back, and two side portions that engage a top edge of the paint roller tray.

38. A paint roller tray comprising:
a tray body comprising
a front wall having a top edge, a front paint roller support notch being formed in the top edge of the front wall, the front paint roller support notch being shaped to complement a paint roller frame,
a back wall having a top edge, a back paint roller support notch being formed in the top edge of the back wall, the back paint roller support notch being shaped to complement a paint roller frame,
opposing spaced side walls joining the front and back walls,
a bottom wall that joins to lower portions of the front, back, and side walls, the bottom wall defining a sloped rollout platform and a paint well, the sloped rollout platform sloping downwardly toward the paint well,
a pour spout formed at an intersection between one of the side walls and the back wall, the pour spout being shaped to pour paint from the paint roller tray, and
a paint brush support disposed in a forward side corner of the tray body, the paint brush support being shaped to support a paint brush; and
a cover removably mounted to the tray body, the cover having a front, a back, and two side portions that engage a top edge of the tray body,
wherein the cover and tray body are shaped to completely enclose a paint roller therebetween.

39. The paint roller tray of claim 38, further comprising a hanging fixture extending forwardly from the front wall, the hanging fixture being shaped to engage a hook such that the paint roller tray hangs on the hook.

40. The paint roller tray of claim 39, further comprising at least one slip-resisting surface feature disposed on a lower surface of the bottom wall.
